(19) United States
(12) Patent Application Publication
(10) Pub. No.: US 2007/0229839 A1
(43) Pub. Date: Oct. 4, 2007

(54) Sensor objective

(76) Inventors: Stefan Franz, Jena (DE); Matthias Fleischer, Ostfildern (DE)

Correspondence Address: KENYON & KENYON LLP, ONE BROADWAY, NEW YORK, NY, 10004, US

(21) Appl. No.: 11/726,175

(22) Filed: Mar. 20, 2007

(30) Foreign Application Priority Data
Mar. 30, 2006 (DE) 102006014765.0

(51) Int. Cl. G01B 9/02

(52) U.S. Cl. 356/477

(57) ABSTRACT

A sensor objective at the exit of a measuring branch of a measuring probe of an interferometric measuring unit for detecting the shape, roughness or distance of the surface of a measured object, the interferometric measuring unit including a modulation interferometer and the measuring probe being optically connected to the modulation interferometer via an optical fiber system and the sensor objective having a focusing element and a downstream deflection element for coupling out and coupling back in a measuring beam directed toward the surface to be measured and reflected from the latter. The deflection element includes at least two optical components, each having a shared interface, the deflection angle of the at least one beam deflected to a system longitudinal axis being settable by mutual displacement and/or rotation of the optical components during mounting. The mutual displacement and/or rotation of the optical components is/are performed at the shared interface(s). Therefore, arbitrary deflection angles for the beam may be set using a small number of optical components which are tailored to one another. Because no components have to be manufactured for specific customers, there is a significant reduction in manufacturing costs as well as significantly shortened manufacturing and therefore delivery times. Because the interfaces of the optical components are joined to one another without a wedge-shaped gap during the gluing of the components after adjustment, the disadvantageous influence of non-reproducible adhesive shrinkage is eliminated.

### FIELD OF THE INVENTION

The present invention relates to a sensor objective at the output of a measuring branch of a measuring probe of an interferometric measuring device for detecting the shape of, roughness of, or the distance to the surface of a measured object, the interferometric measuring device including a modulation interferometer and the measuring probe being optically connected to the modulation interferometer using an optical fiber system and the sensor objective having a focusing element and a downstream deflection element for coupling out and coupling back in a measuring beam which is directed toward the surface to be measured and is reflected by the latter. Furthermore, the present invention relates to a method for manufacturing such a sensor objective.

### BACKGROUND INFORMATION

An interferometric measuring device of the above-mentioned type is described in German Patent Application No. DE 198 19 762. The interferometric measuring device includes a modulation interferometer which has a spatially coherent radiation source and a first beam splitter for splitting its radiation into two partial beams, one of which is shifted in relation to the other in its light phase or light frequency using a modulation unit and which are subsequently unified. Furthermore, it includes a measuring probe, in which the unified partial beams are divided into a measuring beam, which is guided through a measuring branch and reflected on the surface, and a reference beam, which is guided through a reference branch and reflected therein, and in which the reflected reference beam is superimposed on the reflected measuring beam, as well as a suitable receiver unit. The modulation interferometer, which is constructed as a modular unit, is spatially separated from the measuring probe and may be coupled thereto via an optical fiber system. The measuring branch and the reference branch are formed by solid bodies which conduct the measuring beam and the reference beam.

A collimator unit is described at the input of the measuring probe, and a focusing unit and a downstream deflection element for coupling out and coupling back in the measuring beam, which is directed to the surface to be measured and reflected by the latter, are described at the output of the measuring branch. Furthermore, it is described that the measuring branch has at least one further deflection element, via which the measuring beam guided in the measuring branch may be split and directed to a further point of the surface to be measured and the measuring beam reflected thereby may be coupled back into the measuring branch. Measuring probes of the type described are currently manufactured from a glued combination of the connected optical fibers, possibly a spacer, a gradient-index lens (GRIN lens), and one or more prisms. Measuring probes having one or more measuring outputs are used, the measuring outputs being identified by the direction in which the measuring radiation leaves the measuring probe. Exit angles of 90° or 45° are typical; however, measuring probes having other exit angles are also offered for specific customers. The deflection angle is established by the angle of the prisms used. Small angle changes may be achieved by tilted gluing of the prisms.

This construction has the disadvantage that suitable prisms must be provided in accordance with the desired exit angle. If exit angles deviating from the standard deflection angles are to be implemented, the prisms required for this purpose are to be manufactured specially, which results in high costs and long manufacturing time. A slight variation of the exit angle may be achieved by tilted gluing of the prisms, as described. The process for this purpose is difficult to control because of the shrinkage of the adhesive used and results in high reject rates.

It is an object of the present invention to provide a sensor objective of the type mentioned at the outset which avoids the cited disadvantages and allows a large selection of manufacturable deflection angles using a selection of optical components which may be kept in stock.

Furthermore, it is an object of the present invention to provide a method suitable for manufacturing the sensor objective.

### SUMMARY OF THE INVENTION

The object of the present invention is achieved in that the deflection element includes at least two optical components each having a shared interface, the deflection angle of the beam deflected to at least one system longitudinal axis being settable by mutual displacement and/or rotation of the optical components during mounting. The mutual displacement and/or rotation of the optical components is/are performed at the shared interface(s). Therefore, arbitrary deflection angles for the beam may be set using a small number of optical components which are tailored to one another. Because no components must be manufactured for specific customers, this results in a significant reduction in manufacturing costs and in significantly shortened manufacturing and therefore delivery times. Because the interfaces of the optical components are joined to one another without a wedge-shaped gap upon the gluing of the components after adjustment, the disadvantageous influence of non-reproducible adhesive shrinkage is eliminated.

Because the beam deflection is predefinable by reflecting and/or refracting interfaces and exit surfaces of the optical components whose orientation is settable in relation to the system axis, nearly all practically advisable deflection angles may be set for the beam. Smaller deflection angles of the beam in relation to the system axis are implemented via refracting interfaces and exit surfaces, while large deflection angles are achievable using reflecting or partially reflecting interfaces and exit surfaces.

Different setting possibilities for the beam deflection result by implementing the interfaces as planar and/or cylindrical and/or spherical. Planar interfaces are particularly simple to manufacture. They allow the setting of the deflection angle by mutual rotation of the optical components, preferably around their central axis. Both the deflection angle in relation to the system axis and also the radial transmission direction may be set. Cylindrical interfaces allow the deflection angle to be set by rotation of at least one optical component around the cylinder axis, the radial transmission direction being predefined on a plane perpendicular to the cylinder axis. Spherical interfaces allow, as a function of the implementation of the optical components, the deflection angle and the radial transmission direction of the beam to be set by both mutual rotation and mutual displacement around the center point of the sphere. Spherical interfaces are complex to manufacture, but allow simple and precise setting of the deflection angle due to the self-centering effect of the sphere.

A small number of optical components is required for implementing the deflection element because the focusing element is part of the deflection element. For this purpose, the interface between the focusing element and the adjoining optical element is to be designed in such a way that displacement and/or rotation of the optical component in the joint interface results in a change of the orientation of a further interface and/or exit surface of the optical component, at which the direction change of the beam occurs.

In a preferred embodiment of the present invention, the focusing element is implemented as a gradient-index lens (GRIN lens). The GRIN lens allows good focusing of the beam on the surface of the measured object. The beam is focused within the GRIN lens and not by its surface geometry, so that the interface to the adjoining optical component may be selected as freely as possible and no index of refraction change is required at the interface.

A particularly versatile and inexpensively manufacturable embodiment of the deflection element may be achieved by constructing the deflection element from wedge-shaped optical components having planar interfaces. In the event of identical and predefined indices of refraction of the wedge-shaped optical components, the deflection angle of the beam is defined by the orientation of the exit surface. The angle between the system axis and the surface normals of the exit surface may be adjusted, in the event of identical wedge-shaped optical components, by mutual rotation between 0°, i.e., no deflection, and at most twice the aperture angle of a wedge. The combination is capable of setting smaller deflection angles.

After the deflection angle is set to the desired value, the deflection element must be fixed accordingly. For this purpose, the focusing element and/or the optical components of the deflection element are preferably glued to one another.

The object of the present invention relating to the method is achieved in that the optical components of the deflection element are displaced and/or rotated in relation to one another to set the deflection angle, the deflection angle being monitored by measurement, and the optical components are fixed after the desired deflection angle is reached. A particular combination of optical components allows a specific setting range of the deflection angle. The desired deflection angle may be set in the predefined tolerance by monitoring the deflection angle during the adjustment by measurement. Manufacturing tolerances of the optical components used, such as angle tolerances in deflection prisms, are compensated for, so that larger manufacturing tolerances may be permitted for the optical components. The set deflection angle is permanently maintained by fixing the optical components.

### BRIEF DESCRIPTION OF THE DRAWINGS

FIG. 1 shows a sensor objective having a wedge-shaped deflection element.

FIG. 2 shows a sensor objective having a lens-shaped deflection element.

FIG. 3 shows a sensor objective having a prism-shaped deflection element which has a large deflection angle.

FIG. 4 shows a sensor objective having a deflection element which has two output beams.

### DETAILED DESCRIPTION

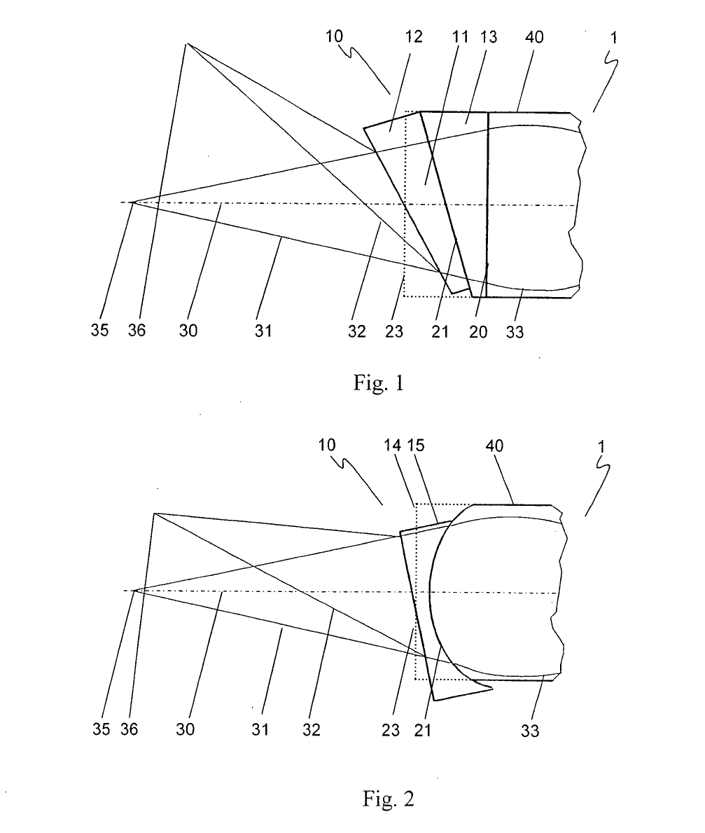

FIG. 1 shows a sensor objective 1 of an interferometric measuring device having a focusing element 40 and a deflection element 10 connected thereto. Focusing element 40 is implemented as a gradient index lens (GRIN). Deflection element 10 is composed of a first wedge-shaped component 13, which adjoins focusing element 40 at an interface 20, and a second wedge-shaped component 11, which adjoins first wedge-shaped component 13 at a planar interface 21. In this position of second wedge-shaped component 11, an incoming beam 33 incident parallel to a system longitudinal axis 30 exits from deflection element 10 at an exit surface 23 perpendicular to system longitudinal axis 30 and is relayed as an undeflected beam 31. The radiation is reflected by a surface of a measured object situated at a focal point 35 of undeflected beam 31 and fed along a reverse beam path into sensor objective 1 of an analysis unit of the interferometric measuring device (not shown).

The deflection angle from undeflected beam 31 to a deflected beam 32 is changed by mounting second wedge-shaped component 11 in a deflection position 12. Exit surface 23 has an angle to system axis 30 deviating from the perpendicular in this position, so that the radiation is refracted away from system axis 30 upon the transition from an optically dense medium into a thinner medium. The deflection angle may be increased continuously from undeflected beam 31 up to the deflection angle of deflected beam 32 by rotating second wedge-shaped optical component 11 around system longitudinal axis 30. In this deflection position 12 of second wedge-shaped component 11, the radiation is focused on a surface of a measured object situated at a focal point 36 and is reflected thereby.

FIG. 2 shows a sensor objective 1 having a focusing element 40 and an undisplaced lens 14 connected thereto at interface 21. In this position of the 14, incoming beam 33 entering parallel to system axis 30 exits deflection element 10 at exit surface 23, which is oriented perpendicularly to system longitudinal axis 30, and is relayed as undeflected beam 31 to focal point 35. Interface 21 is implemented as a cylinder surface or as a spherical section and is thus a part of deflection element 10 which is integrated in focusing element 40. Lens 14 may also be mounted as a displaced lens 15 due to curved interface 21. In this position, incoming beam 33 is refracted at exit surface 23, which is tilted toward the system axis, and conducted to focal point 36 as deflected beam 32. Lens 14 may be implemented as a GRIN lens in an expanded embodiment.

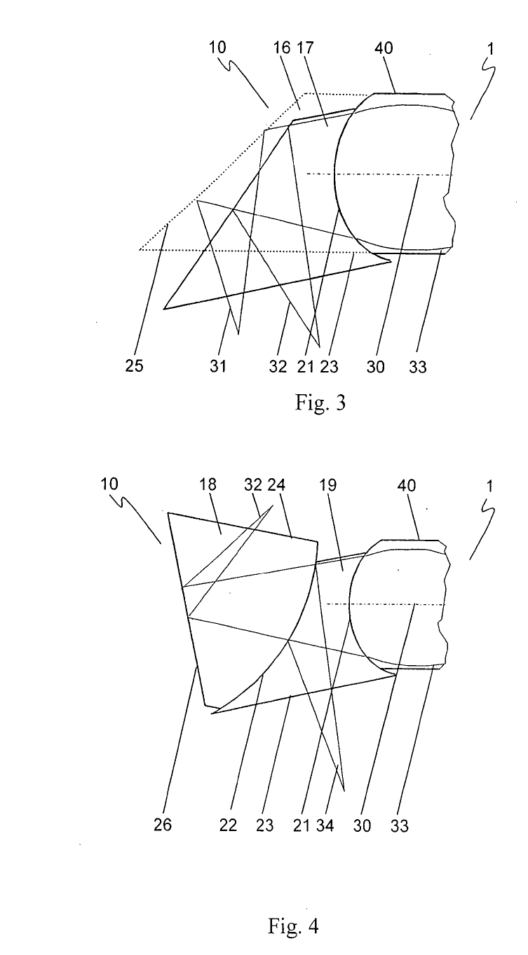

A sensor objective for large deflection angles is illustrated in FIG. 3. In a starting position of a deflection prism 16, incoming beam 33 is reflected at a reflection surface 25 after passage through a spherical or cylindrical interface 21 and leaves sensor objective 1 as beam 31 through exit surface 23 at a large angle to system longitudinal axis 30. In the position as displaced deflection prism 17, the deflection angle is enlarged in relation to system longitudinal axis 30, so that incoming beam 33 leaves sensor objective 1 as deflected beam 32. In this configuration. as well, the radiation is reflected by the object to be measured and guided back into the interferometric measuring unit on the beam path.

FIG. 4 shows a sensor objective 1 having two output beams exiting at different angles. Deflection element 10 includes curved interface 21 of focusing element 40, a first deflection prism 19, and a second deflection prism 18 here. Incoming beam 33 passes through spherical or cylindrical interface 21 into first deflection prism 19 and is incident on an interface 22. This interface 22 is partially reflective, so that a part of the radiation passes into second deflection prism 18 and another part is reflected and leaves the configuration as deflected beam 34. The radiation component entering second deflection prism 18 is reflected at a reflection surface 26 and leaves second deflection prism 18 as deflected beam 32 at a large angle to system longitudinal axis 30. By rotating first deflection prism 19 in relation to focusing element 40 along interface 21, the exit angle of deflected beam 34 may be set in relation to system axis 30. By rotating second deflection prism 18 in relation to first deflection prism 19 along interface 22, the exit angle of deflected beam 34 may be set in relation to system axis 30. Therefore, the angle between both deflected beams 32, 34 may also be set using this configuration.

What is claimed is:

1. A sensor objective at an output of a measuring branch of a measuring probe of an interferometric measuring device for detecting at least one of a shape, a roughness and a distance of a surface of a measured object, the interferometric measuring device including a modulation interferometer and the measuring probe being optically connected to the modulation interferometer using an optical fiber system, the sensor objective comprising:
a focusing element and a downstream deflection element for coupling out and coupling back-in a measuring beam which is directed to the surface to be measured and is reflected by the surface, the deflection element including at least two optical components, each having a shared interface, a deflection angle of at least one beam deflected to a system longitudinal axis being settable by at least one of a mutual displacement and rotation of the optical components during mounting.

2. The sensor objective according to claim 1, wherein the beam deflection is predefinable by at least one of (a) reflecting interfaces and (b) light-refracting interfaces, and exit surfaces of the optical components which are settable with respect to an orientation in relation to the system axis.

3. The sensor objective according to claim 1, wherein the interfaces are at least one of planar, cylindrical and spherical.

4. The sensor objective according to claim 1, wherein the focusing element is part of the deflection element.

5. The sensor objective according to claim 1, wherein the focusing element includes a gradient-index lens.

6. The sensor objective according to claim 1, wherein the deflection element is constructed from wedge-shaped optical components having planar interfaces.

7. The sensor objective according to claim 1, wherein the focusing element and the optical components of the deflection element are glued to one another.

8. A method for manufacturing a sensor objective comprising:
at least one of displacing and rotating optical components of a deflection element in relation to one another to set a deflection angle;
monitoring the deflection angle by measurement; and
fixing the optical components after a desired deflection angle is reached.
